(19) United States
(12) Patent Application Publication
(10) Pub. No.: US 2024/0095309 A1
(43) Pub. Date: Mar. 21, 2024

(54) SYSTEM AND METHOD FOR HOLISTICALLY OPTIMIZING DNN MODELS FOR HARDWARE ACCELERATORS

(71) Applicant: COCOPIE INC., Palo Alto, CA (US)

(72) Inventor: Daniel Song Shen, Palo Alto, CA (US)

(21) Appl. No.: 17/933,119

(22) Filed: Sep. 18, 2022

(51) Int. Cl. G06K 9/62

(52) U.S. Cl. CPC G06K 9/6265

(57) ABSTRACT

In some implementations, the invention may include the generation of a quantitative hardware performance model based on the obtained hardware specification via a computing platform. In addition, the invention may include obtaining a starting DNN model and DNN performance requirements for the optimized DNN model. The invention may include the generation of a DNN performance model based on the received starting DNN model and the received DNN performance requirements. Moreover, the invention may include the generation of an optimized DNN model through applying the quantitative hardware performance model and the DNN performance model to an optimization space of a plurality of DNN model instances.

### FIELD OF THE INVENTION

The present disclosure relates to neural networks in general, and more specifically to deep neural network model optimization.

### BACKGROUND OF THE INVENTION

Adoption of AI across various domains have been spurred on by recent advances in Deep Learning, but there continues to be a mismatch between the achieved performance of DNN models and the full power of the underlying hardware. Solving this mismatch is complicated on both hardware and DNN sides. On one hand, as exemplified by the large reconfigurable space of NVDLA, various properties make hardware accelerators diverse. Simultaneously, factors in both model transformations and code generation, two interdependent aspects, render DNN optimization a complex problem of its own. This invention proposes optimal mapping via impressionistic holistic optimization (OMIHO) as the first general coupled approach to the problem. This method's distinctive features include the employment of a novel impressionistic refinement scheme, which, coupled with hybrid model-driven assessment, make it possible for OMIHO to explore the vast optimization space quickly and effectively. Additionally, it is widely generalizable, holistic, and provides near optimal solutions through a hybrid optimizing method that combines analytical methods and search-based methods.

### SUMMARY OF THE INVENTION

In one general aspect, a computing platform generates a quantitative hardware performance model based on the obtained hardware specification of the target device. The computing platform also obtains through user input a starting DNN model and DNN performance requirements for the desired optimized DNN model. A DNN performance model can then be further generated from the received starting DNN model and the received DNN performance requirements. Through the application of the quantitative hardware performance model and the DNN performance model to an optimization space of a plurality of DNN model instances, the optimized DNN model can be generated. Other embodiments of this aspect include corresponding computer systems, apparatus, and computer programs recorded on one or more computer storage devices, each configured to perform the actions of the methods.

Implementations may include one or more of the following features. The hardware specification of the target device specifies architecture, execution models and performance recipes of the target device. The hardware performance builder is configured to perform one or more of the following: generating the architectural specification of the target device; generating one or more hardware performance models on one or more common DNN operations through active profiling and/or linear curve fitting; and generating one or more performance recipes based on the hardware architectural specification and the one or more hardware performance models. Further, the DNN performance builder can be configured to perform at least one of the following: determining, for each layer in the received starting DNN model, a DNN performance model through active profiling; generating a statistical description to capture one or more dynamic features of a DNN model. the generating of the desired optimized DNN model further may include iteratively performing impressionistic refinement to the optimization space and applying hybrid model-driven assessment on the plurality of DNN model instances. Implementations of the described techniques may include hardware, a method or process, or a computer tangible medium.

### BRIEF DESCRIPTION OF THE DRAWINGS

The embodiments are illustrated by way of example and not limitation in the figure of the accompanying drawings in which like references indicate similar elements.

FIG. 1 is a block diagram illustrating an overall system architecture for the claimed optimal mapping via impressionistic holistic optimization to deep neural network models for given hardware where the thus optimized DNN models are to be deployed according to one embodiment of the present disclosure.

FIG. 2 is a flow diagram that depicts how hardware and DNN specifications and requirements are obtained and then utilized to create the optimized DNN model according to one embodiment of the present disclosure.

FIG. 3 is a block diagram illustrating a descriptive interface for hardware specification according to one embodiment of the claimed unified approach to hardware specification.

FIG. 4 is a flow diagram that illustrates the process of the heterogeneous hardware performance builder, according to one embodiment of the present disclosure.

FIG. 5 is a flow diagram of a DNN performance builder according to one embodiment of the present disclosure.

FIG. 6 is a flow diagram of the coupled optimal optimization engine according to one embodiment of the present disclosure.

FIG. 7 shows a flow diagram that illustrates the core process of the coupled optimal optimization engine according to another embodiment of the present disclosure.

FIG. 8 shows the pseudo-code of the overall algorithm of coupled optimal optimization engine according to one embodiment of the present disclosure.

### DETAILED DESCRIPTION

The inventors have recognized that the present disclosure would be of great benefit to the development of the field of machine learning and aid in bridging the gap between the achievable performance of DNN models and the full power of the underlying hardware. The present disclosure offers advantages in optimizing machine learning models not just for a target device based merely on a name or type of the target device, but also offers a more principled approach and architecture to the incorporation of hardware features into the DNN optimization process.

The following disclosure provides many different embodiments, or examples, for implementing different features of the provided subject matter. Specific examples of components and arrangements are described below to simplify the present disclosure. These are, of course, merely examples and are not intended to be limiting.

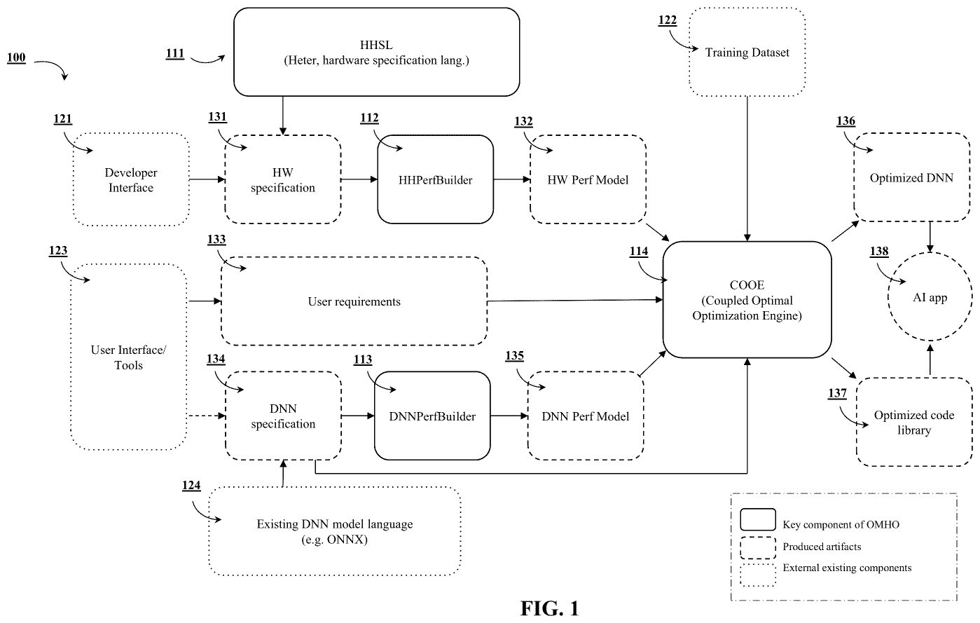

FIG. 1 outlines the overall system architecture for the claimed optimal mapping via impressionistic holistic optimization 100 to deep neural network models for given hardware where the thus optimized DNN models are to be deployed according to one embodiment of the present disclosure. The solid boxes are the key components of OMIHO 100 of the present disclosure, the dashed boxes are the produced intermediate and final artifacts, and the dotted boxes are some components well known in the field. The architecture of OMIHO 100 consists of the following three main subsystems:

Subsystem #1. For a target hardware where the generated code of the optimized DNN model is intended to run, the developers provide a hardware (HW) specification 131 through a hardware specification module with the help of heterogeneous hardware specification language (HHSL) compiler 111 and a developer interface 121. The HW specification 131 specifies the relevant architecture and features of the target hardware.

Based on the HW specification 131, a Heterogeneous Hardware Performance Builder (HHPerfBuilder) 112 creates a quantitative HW performance model 132. This step may be a one-time effort for a given hardware according to one embodiment of the present disclosure. Alternatively, it can be an iterative process that includes fine tuning, using different sets of training data, according to another embodiment of the present disclosure.

Subsystem #2. A user who wants to attain optimized deep neural network (DNN) models or code provides her requirements 133 to the user interface 123, such as the needed accuracy of the DNN, the target hardware and the desired speed of the DNN execution on the target hardware. In addition, she may provide the specification of the base DNN 134 (e.g., the architecture of Resnet-50) through certain tools. In one embodiment of the present disclosure, the DNN specification 134 specifies the types and dimensions of the layers of the base DNN and the connections among the layers of the base DNN. In some other embodiment, the DNN specification 134 may come from other sources (e.g., derived by some automatic tools from existing DNN implementations 124). The open format built to represent machine learning models, ONNX, is one example of such automatic tool. Based on the DNN specification 134, a DNN Performance Builder (DNNPerfBuilder) 113 then creates the DNN performance model 135 for the target DNN, including the number of computations at each layer, the probabilities of taking certain branches of the base DNN model, or branches of the evolved/DNN model that is still being optimized, or both, and so on.

Subsystem #3. Based on the hardware performance model 132, the DNN performance model 135, and the user requirements 133, the coupled optimal optimization engine (COOE) 114 figures out and applies the best optimizations to the starting DNN model and its corresponding code generation process. CODE 114 thus produces the optimally optimized DNN model 136 and its optimal implementation in the form of a binary code library 137. The optimality here is defined with respect to the user requirements 133. The generated optimized DNN model 136 and its corresponding code library 137 can then be deployed in AI applications 138.

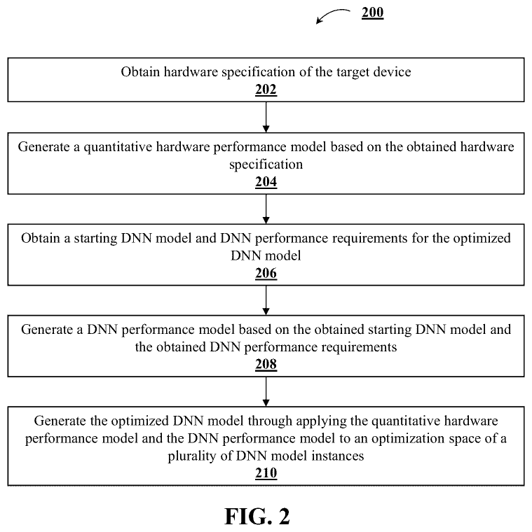

FIG. 2 is a flow diagram of an overall process to generating the optimized DNN models through the various modules as described above, according to some embodiments of the present disclosure. The process blocks of FIG. 2 demonstrate how specifications and performance requirements for the target device and DNN, respectively, are obtained and how the resulting performance models are generated.

First, at step 202, hardware specification of the target device is obtained. Second, at step 204, a quantitative hardware performance model based on the obtained hardware specification is generated. Then, at step 206, a starting DNN model and DNN performance requirements for the optimized DNN model are then obtained. Next, at step 208, a DNN performance model based on the obtained starting DNN model is generated. Last, at step 210, the quantitative hardware performance model and the DNN performance model are applied to the optimization space of a plurality of DNN model instances to generate the more optimized DNN model that meets the obtained DNN performance requirements.

It should be noted that while FIG. 2 shows the steps of the overall process 200 in some implementations, those skilled in the art will appreciate that process 200 may include additional steps, fewer steps, different steps, or differently arranged steps than those depicted in FIG. 2. Additionally, or alternatively, two or more of the steps of process 200 may be performed in parallel; a shown step may be divided into sub-steps, etc.

Next, the design of each of the key components in OMIHO is described.

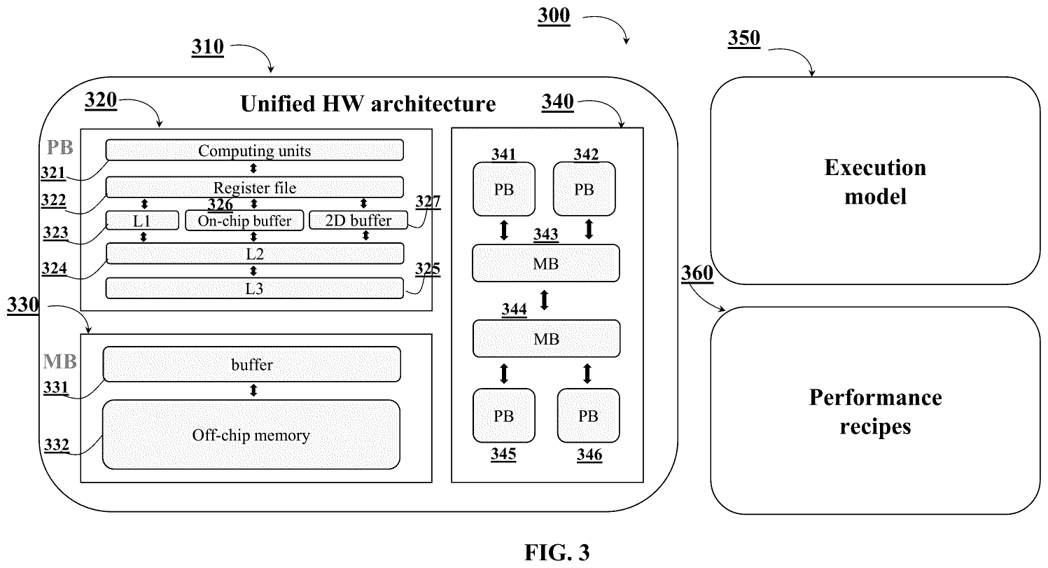

FIG. 3 illustrates a descriptive interface 300 for hardware specification consisting of three subparts: unified hardware architecture module 310, execution model 350 and performance recipes module 360 according to one embodiment of the claimed invention. In FIG. 3, a heterogeneous hardware specification language (HHSL) as a unified approach to HW specifications is disclosed.

In FIG. 3, the unified hardware architecture module 310 generates an abstraction that subsumes most common computer architecture components. In another word, most common computing devices can be expressed as a concrete instance of that abstract architecture, instantiated with configurations of each of its components. According to one embodiment, the abstract architecture includes two constructs, processing block (PB) 320 and memory block (MB) 330. A PB 320 usually corresponds to a processor, such as an Intel quad-core i5, or a NVDIA Volta.

As shown in FIG. 3, according to one embodiment, a PB 320 is a graph composed of seven types of primary constructs, respectively representing computing units 321, register files 322, three levels of hardware cache 323, 324, 325, on-chip 1D buffers 326 and 2D buffers 327. According to one embodiment, if a processor does not contain any of a particular construct, the size of that construct is set to 0. For example, in the case of Intel quad-core core i5, there are four computing units 321 of 2 GHz but neither 1D on-chip buffer 326 nor 2D on-chip buffer 327, so the size of computing units 321 is set to 4, the size of 1D on-chip buffer 326 is set to 0, and the size of 2D on-chip butter 327 is also set to 0. As another example, for an NVIDIA Volta, the size of CUDA computing units 321 is consists of 5,120, the size of Tensor computing units 321 is 640, and the size of 1D on-chip buffers 326 and 2D on-chip buffers 327 (also called shared memory and texture cache) are set to certain numbers based on a particular configuration. In some embodiments, an MB 330 corresponds to the off-chip memory 332. MB 330 often has some buffers 331 (e.g., row buffer in DRAM). The overall architecture module 340 illustrates the interconnections of the PBs 341, 342, 345, and 346 and MBs 343 and 344 according to some embodiments.

In the hardware specifications of the unified hardware architecture 310 as well as PB 320 and MB 330, it is critical to clearly specify the interconnections between the components because their specific connections have an impact on the bandwidth and latency of resulting optimized DNN models for a given target device. It is therefore for a person skilled in the art to understand that the specification of the unified architecture for a target device as disclosed here provides the low-level architectural information about the target device.

In FIG. 3, module 350 specifies the execution model of programs on the device on which the optimized DNN model is going to be deployed. In many cases, an execution model includes a threading model. In one embodiment using a NVIDIA GPU, for instance, threads are organized into warps and thread blocks, where the threads in a warp execute in lock steps. In some embodiments, some threads in one thread block share an on-chip buffer, while other thread blocks do not share an on-chip buffer.

In FIG. 3, performance recipes module 360 specifies high-level recipes, which may include both hardware constraints and rules on the preferred computation or data-related patterns for performance.

According to one embodiment, one high-level recipe is the 2:4 sparse pattern preferred by NVIDIA Ampere. On the NVIDIA A100 GPU, a 2:4 sparse pattern is essential for performance: out of every four elements, at least two must be zero. This pattern allows the Ampere hardware to reduce the data footprint and bandwidth of one matrix multiply (also known as GEMM) operand and improve throughput by skipping the computation of the zero values using new NVIDIA Sparse Tensor Cores.

In another embodiment, a high-level recipe includes regular patterns which are required for the effective usage of SIMD units on Qual-comm Snapdragon CPUs and GPUs. Both Snapdragon CPUs and GPUs prefer kernels with computations of multiple of 4 due to their SIMD hardware implementation (e.g., Snapdragon CPUs have 4 SIMD lanes); however, DNN kernels usually have 3×3 or 5×5 weights that prevent execution from reaching perfect SIMD utilization. If a weight pruning preserves 4 weights (or other numbers of weights that are multiple of 4), it can better fit the computation to the SIMD hardware.

In yet another embodiment, a high-level recipe is the desired patterns in the input matrices that compilers can leverage to further optimize the data layout and improve the memory/register performance by reducing redundant memory/register accesses.

To ease the creation of the unified HW specification (e.g., 131 of FIG. 1, or 300 of FIG. 3) and to make the specification comprehensible by the automatic optimizer COOE (e.g., 114 of FIG. 1), a descriptive domain-specific programming language HHSL is disclosed. HHSL is built upon XML, composed of a set of constructs customized to the building blocks in unified HW architecture, execution model, and performance recipes. Unlike the other two components, performance recipes do not have a predefined vocabulary: a new HW may have a completely new favorite pattern of operations.

According to one embodiment, HHSL provides the constructs sufficient for specifying the recipes for common computing devices, and at the same time, has an extensible mechanism. The mechanism allows the addition of recipes expressed in the form of external programming code that transform a DNN implementation. Such an external recipe must follow the predefined interface specified in HHSL.

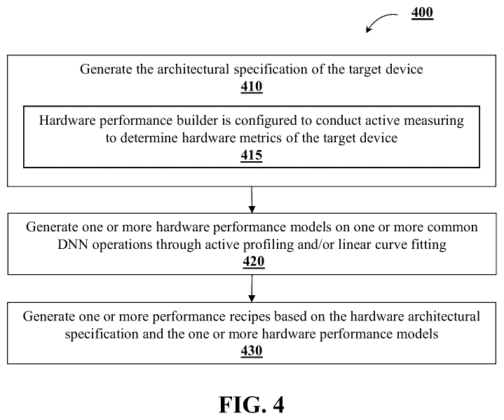

FIG. 4 illustrates the process of the heterogeneous hardware performance builder (e.g., 112 of FIG. 1) through which it builds up the performance models of the target hardware. The generated performance models can be used by COOE (e.g., 114 of FIG. 1) in optimizing any given base DNNs.

The HHPerfBuilder process begins with completing the architectural specifications at step 410 according to some embodiments. In some embodiment, due to the lack of completeness in hardware disclosures, it is common that some parts (e.g., L1 cache latency, size of the register file, the capacity of the memory row buffer) in an HW specification are missing. Thus, HHPerfBuilder (e.g., 113 of FIG. 1) must first fill those gaps through active measuring via microkernels in step 415, an approach that runs a set of microkernels to figure out the hardware metrics. Many microkernels exist for measuring the latencies of a memory hierarchy, register file size, and other attributes, which HHPerfBuilder can later draw on throughout the process.

Next, in step 420, a quantitative hardware performance model based on the obtained hardware specification is generated by the computing platform. According to some embodiments, HHPerfBuilder (e.g., 113 of FIG. 1) is to establish a set of performance models on some primary operations that are common to DNNs, such as matrix multiplications, normalizations, etc. HHPerfBuilder (e.g., 113 of FIG. 1) does this through active profiling 420, running a set of variations of a primary operation (e.g., matrix multiplications in many different shapes and sizes in various data layouts), and recording the performance of each variation. In some embodiments, linear curve fitting is used to complete the performance models 420. These models offer conveniences to COOE during its search for the optimal optimizations as discussed below.

As further shown in FIG. 4, a starting DNN model and DNN performance requirements for the optimized DNN model can be then obtained in step 430. Another main task of HHPerfBuilder is to crystallize the observations of the hardware features and active profiling measurements into performance recipes during step 430. Examples of the performance recipes may include the rules about the relations between matrix shapes and the appropriate data layouts in memory. The recipes are in form of a decision tree or external programs that comply with the extensible interface of HHSL (e.g., 111 of FIG. 1).

It should be noted that while FIG. 4 shows the steps of the process 400 in some implementations, those skilled in the art will appreciate that process 400 may include additional steps, fewer steps, different steps, or differently arranged steps than those depicted in FIG. 4. Additionally, or alternatively, two or more of the steps of process 400 may be performed in parallel; a shown step may be divided into sub-steps, etc.

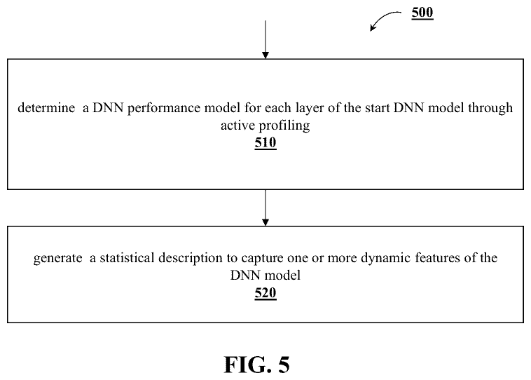

FIG. 5 is a flow diagram of the workflow 500 of the DNN performance builder (DNNPerfBuilder (e.g., 113 of FIG. 1), according to one embodiment of the present disclosure. The DNNPerfBuilder creates the performance models of the DNN of interest. The workflow 500 may include additional implementations, such as any single implementation or any combination of implementations described below and/or in connection with one or more other processes described elsewhere herein. DNN performance builder operations comprise two main acts.

First, in act 510, DNNPerfBuilder determines a performance model for each layer of the start DNN model. If the layer is one of the common layers, its performance model is already contained in the models from the HHPerfBuilder; the focus of DNNPerfBuilder is on the other layers. This approach is also called active profiling, as described earlier.

Second, in act 520, DNNPerfBuilder is to generate a statistical description to capture one or more dynamic features of the start DNN model. According to some embodiments, this comprises capturing and creating a model of the conditional branches of the DNN model at act 520. This task is specific to DNNs with dynamic features, such as branches. Examples of such DNN models include some computer vision DNN models, which bypass some layers if the inputs meet certain conditions. For such DNN models, DNNPerfBuilder runs the DNNs on many representative inputs to build up a statistical model to then capture the branch-taking probabilities during act 520. The statistical model can be flexible with different degree of sophistication depending on the starting DNN model and intended applications. For some embodiments, the statistical model can be simple as just having distributions of the taking probabilities of each branch. For some other embodiments, the statistical model can be complex as consisting of machine learning models that take in the features of the input data and predict the frequencies of the branches that will be taken by the execution of the DNN on the input data.

It should be noted that while FIG. 5 shows the steps of the process 500 in some implementations, those skilled in the art will appreciate that process 500 may include additional steps, fewer steps, different steps, or differently arranged steps than those depicted in FIG. 5. Additionally, or alternatively, two or more of the steps of process 500 may be performed in parallel; a shown step may be divided into sub-steps, etc.

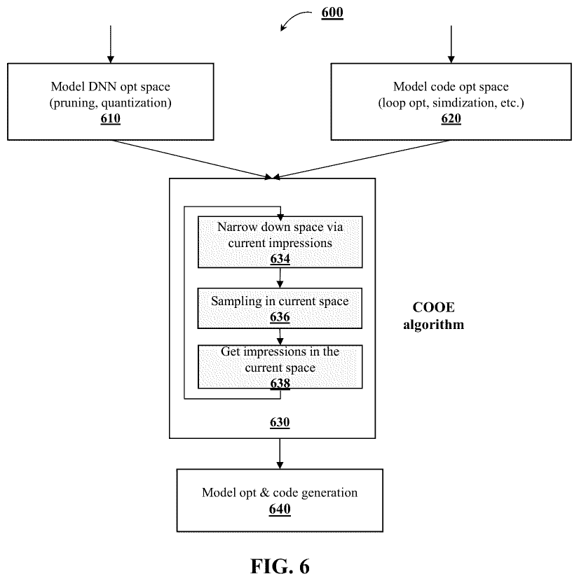

Next we turn to FIG. 6, which shows how CODE (e.g., 114 of FIG. 1) can be used with the performance models built by HHPerfBuilder (e.g., 112 of FIG. 1) and DNNPerfBuilder (e.g., 113 of FIG. 1) to find the optimal optimizations for the DNN model of interest. The challenge lies in the vast possibilities of optimizations. Both the DNN model and the code generation must be optimized to generate the best code, but optimizations of each have a large search space.

In step 610, the model optimization space is first characterized at the model level by the set of options for model pruning and model quantization. The former removes some or parts of filters, network connections, or layers to make the model smaller; the latter reduces the precision of the network parameters such that one weight can be represented in a smaller number of bits. Both pruning and quantization can reduce the size of the DNN network and the total amount of computations involved in the executions of the DNN model, but both have a large configuration space as the configurations grow exponentially as the size of the network increases. For pruning, the configurations are about what part of the network to prune, while for quantization, the configurations are about what precisions to use for each part of the network.

In general, code optimization includes all the decisions and parameters in the translation of the DNN models into binary code, ranging from data layout on memory to loop ordering, loop unrolling, loop tiling, kernel fusions, simdization, and so on. A wide range of choices exist in each of the dimensions, and together, they form a large combinatorial space. According to some embodiments, in step 620, the model code optimization space may be reduced by focusing on loop optimizations.

The difficulty in finding the best optimizations is compounded by the interplay among the optimizations. For instance, changes in loop schedules could affect what data layouts work better than others. Similarly, there is interdependence between model optimizations and code optimizations. Thus, how the network is pruned or quantized could potentially affect what optimizations work best in the code transformations; if the kernels in the DNN are pruned in a certain pattern, the best code generation (e.g., the use of certain vector intrinsics) could differ.

To tackle the difficulties caused by the vast optimization space and the interplay among the optimizations, COOE is disclosed which utilizes impressionistic refinement and hybrid model-driven assessment.

Returning to FIG. 6, according to some embodiments, a refined optimization space of DNN model instances is determined based on optimization recipes and the DNN performance model and the hardware performance model in step 630. The refined optimization space is narrowed down to a pre-determined size by iteratively selecting a subset of the DNN model instances in the refined optimization space in step 636 and measuring effects on various metrics of DNN model instances in 638. Various metrics comprise of at least one item selected from the group consisting of speed, accuracy, size, power consumption, energy and memory.

According to some other embodiments, the key to impressionistic refinement is an iterative process to gradually focus the search to the most promising subspaces as shown in FIG. 6 as block 630. At each iteration, it tries to “draw an impressionistic image” of the performance of the DNN model in the space of interest. Here, the term “an impressionistic image” comes from an analogy of impressionism in painting, referring to a high-level characterization of how the performance of the DNN varies in the space of optimizations. Initially, the optimization recipes in the HW performance model provide the first impressionistic image and then, based on that model, COOE derives a subspace worth focusing on (e.g., in step 636). For example, based on the recipe on Snapdragon GPU on suitable patterns for DNN kernels, COOE narrows the optimization space down to a subspace that focuses DNN pruning on those patterns.

In the following iterations, the impressionistic images are created by COOE through coarse-grained sampling, which collects the approximated performance, such as speed and accuracy of the DNN network at select sample configurations of the DNN model and code optimizations, as shown in step 638. After each iteration, COOE narrows down the promising subspace based on the “impressionistic image” in step 634. Assume that in each iteration, one of n subspaces is chosen for the exploration in the next iteration; the number of subspaces saved by this search strategy grows exponentially with the number of iterations, thus providing a feasible way to combat the exponentially growing space of optimizations.

However, a hybrid model-driven assessment is additionally necessary as even with the impressionistic refinement strategy, there can still be many DNN instances that need assessment. Empirically running each instance to measure the performance is time intensive and slows down optimization. COOE uses a hybrid model-driven approach that both uses the HW and DNN performance models to analytically infer the speed of the DNN instances and uses sampling and interpolation to infer the accuracy of the DNN instances.

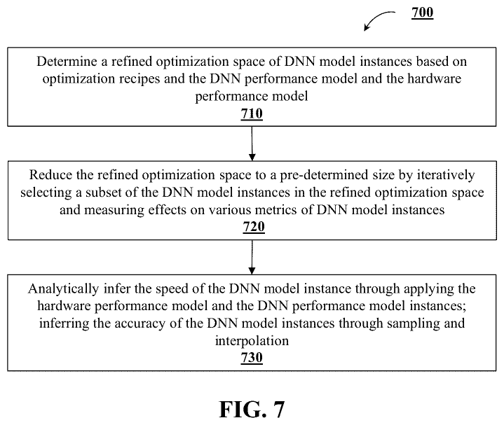

FIG. 7 is a flow chart that illustrates the generation of the optimized DNN model through iteratively performing impressionistic refinement to the optimization space and applying a hybrid model-driven assessment according to another embodiment of the present disclosure.

Process 700 may include additional implementations, such as any single implementation or any combination of implementations described below and/or in connection with one or more other processes described elsewhere herein.

In a first implementation, as shown in step 710, a refined optimization space of DNN model instances is determined based on optimization recipes, the DNN performance model, and the hardware performance model.

In a second implementation, as shown in step 720, the refined optimization space is reduced to a pre-determined size by iteratively selecting a subset of the DNN model instances in the previously refined optimization space and measuring effects on various metrics of DNN model instances. Examples of the various metrics may include at least one item selected from the group having of speed, accuracy, size, power consumption, energy, and memory.

In a third implementation, as shown in step 730, a hybrid model-driven assessment is performed, either alone or in combination with the first and second implementation. This includes analytically inferring the speed of the DNN model instances through applying the hardware performance model and the DNN performance model to the DNN model instances and inferring the accuracy of the DNN model instances through sampling and interpolation.

It should be noted that while FIG. 7 shows example steps of process 700, in some implementations, process 700 may include additional steps, fewer steps, different, or differently arranged steps than those depicted in FIG. 7. Additionally, or alternatively, two or more of the steps of process 700 may be performed in parallel.

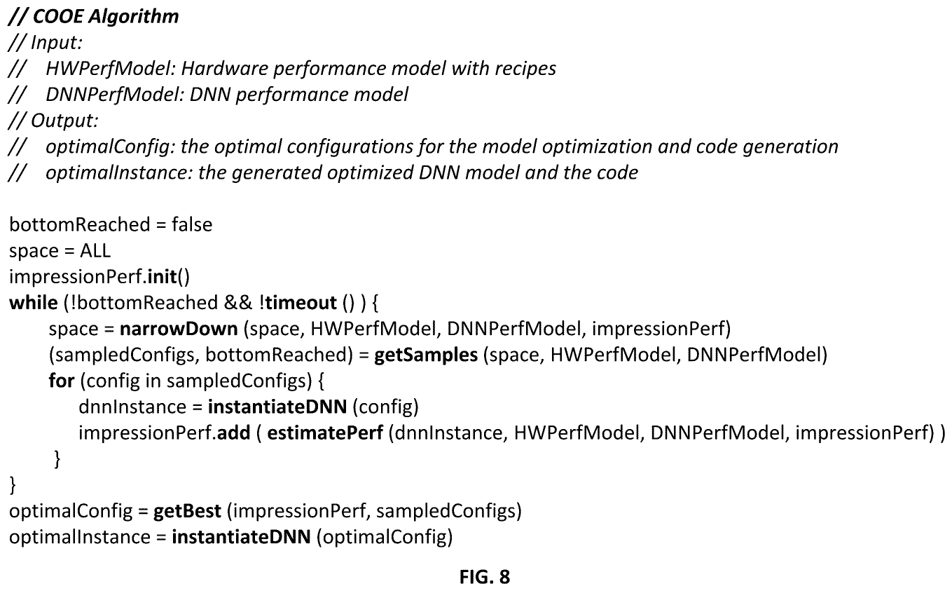

FIG. 8 shows the pseudo-code of the overall algorithm of COOE. At its core is a while loop, which terminates when the exploration of the search space either finds the best configuration or times out. Each iteration of the while loop consists of three steps, which are explained in the following passages.

First, based on the current performance models and the “impressionistic” images of the performance of the search space, COOE narrows down the search to one or more subspaces, stored in variable space.

Second, based on the performance models, a set of samples in the current space is created and stored in variable sampledConfigs. If the current space is already at the bottom level (i.e., no further subspace is to be explored), variable bottomReached is set to true.

Finally, the impressionistic images of the performance of the DNN in the current space are obtained. This includes instantiating the DNN with each of the sampled configuration, and then estimating the performance of the DNN instance. The estimation is performed via the aforementioned hybrid model-driven assessment approach. It uses the performance models, the impressionistic images, or profiling (only when necessary) to then estimate the performance. After the search is completed, the algorithm identifies the best configuration and generates the corresponding DNN instance and code.

The foregoing disclosure provides illustration and description, but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for obtaining an optimized Deep Neural Network (“DNN”) model to run on a target device that maximizes the DNN performance on the target device, the method comprising:
obtaining, in a computing platform, hardware specification of the target device;
generating, by the computing platform, a quantitative hardware performance model based on the obtained hardware specification;
obtaining, in the computing platform, a starting DNN model and DNN performance requirements for the optimized DNN model;
generating, by the computing platform, a DNN performance model based on the obtained starting DNN model and the obtained DNN performance requirements; and
generating, by the computing platform, the optimized DNN model and code through applying the quantitative hardware performance model and the DNN performance model to an optimization space of a plurality of DNN model instances and code optimizations.

2. The method of claim 1, wherein the hardware specification of the target device specifies architecture, execution models and performance recipes of the target device.

3. The method of claim 1, wherein the target device is one of a plurality of platforms comprising servers, workstations, personal computing devices, mobile phones, embedded devices, specialized accelerators, FPGAs and ASICs.

4. The method of claim 2, wherein the hardware specification is described in heterogeneous hardware specification language.

5. The method of claim 2, wherein the architecture of hardware specification specifies both processing blocks and memory blocks of the target device and interconnections of the processing blocks and the memory blocks.

6. The method of claim 2, wherein the execution models comprising thread models and synchronization schemes and constraints.

7. The method of claim 2, wherein the performance recipes comprise one or more hardware constraints, one or more rules on preferred computation patterns, and one or more rules on preferred data storage and access patterns.

8. The method of claim 1, wherein the generating hardware performance model comprises one or more of the following:
generating architectural specification of the target device;
generating one or more hardware performance models on one or more common DNN operations through active profiling and/or linear curve fitting; and
generating one or more performance recipes based on the architectural specification and the one or more hardware performance models.

9. The method of claim 8, wherein the generating architectural specification comprises conducting active measuring to determine hardware metrics of the target device, wherein hardware metrics include at least one item selected from the group consisting of memory hierarchy, processor speed, and register file size.

10. The method of claim 8, wherein the one or more common DNN operations comprise tensor multiplications of a plurality of shapes and sizes, tensor normalization, linear and non linear tensor transformations.

11. The method of claim 8, wherein the one or more performance recipes comprises a decision tree, rules, external executable functions.

12. The method of claim 1, wherein the generating a DNN performance model comprises one or more of the following:
determining, for each layer in the obtained starting DNN model, a DNN performance model through active profiling; and
generating a statistical description to capture one or more dynamic features of a DNN model.

13. The method of claim 12, wherein the one or more dynamic features of the DNN model the DNN model instances comprise conditional branching characteristics and parameters of the DNN performance models.

14. The method of claim 12, wherein the statistical description comprises:
distributions of probabilities of taking each branch; and/or one or more machine learning models, wherein the one or more machine learning models are capable of predicting frequencies of branching taken by the DNN model running for certain input data, and running speed or amount of calculations of the DNN model.

15. The method of claim 1, wherein the generating the optimized DNN model further comprises iteratively performing impressionistic refinement to the optimization space and applying hybrid model-driven assessment on the plurality of DNN model instances.

16. The method of claim 15, wherein the impressionistic refinement comprises:
determining a refined optimization space of DNN model instances based on optimization recipes and the DNN performance model and the hardware performance model; and
reducing the refined optimization space to a pre-determined size by iteratively selecting a subset of the DNN model instances in the refined optimization space and measuring effects on various metrics of DNN model instances under various code optimizations,
wherein the various metrics comprises at least one item selected from the group consisting of speed, accuracy, size, power consumption, energy and memory.

17. The method of claim 16, wherein the hybrid model-driven assessment comprises:
analytically inferring the speed of the DNN model instances through applying the hardware performance model and the DNN performance model to the DNN model instances; and
inferring the accuracy of the DNN model instances through sampling and interpolation.

18. The method of claim 1, further comprises generating the corresponding optimized binary code library of the optimized DNN model.

19. The method of claim 9, wherein the active measuring comprises running a set of micro-kernels on the computing platform.
